(19) United States
(12) Patent Application Publication
(10) Pub. No.: US 2021/0275877 A1
(43) Pub. Date: Sep. 9, 2021

(54) BALL RETRIEVING DEVICE

(71) Applicant: Arthur R. Bateman, IV, The Villages, FL (US)

(72) Inventor: Arthur R. Bateman, IV, The Villages, FL (US)

(21) Appl. No.: 16/812,315

(22) Filed: Mar. 8, 2020

(51) Int. Cl. A63B 47/02

(52) U.S. Cl. CPC A63B 47/02

(57) ABSTRACT

A ball retrieving device is provided. The device includes a storage receptacle, and a collector tube attached to the storage receptacle. A cover includes a flange assembly connected to a disgorging tube. The ball retrieving device can be configured in a ball retrieving configuration, a stand configuration, and a storage configuration.

### FIELD OF THE INVENTION

The present invention relates generally to devices used for retrieving, collecting, and storing balls that may scatter in the course of play or practice. In particular, the invention relates to devices which operate to easily collect and store balls used in the sport of pickleball, without the need for bending in order to avoid injuring a user's back, make the play area safe for players, save time, and conveniently store unused balls for future play.

### BACKGROUND

Pickleball is a paddleball sport that combines elements of tennis, badminton, and table tennis. Two or four players use paddles made of wood or composite materials to hit a ball over a net. The sport shares features of other racquet sports; the dimensions and layout of a badminton court, and a net and rules somewhat similar to tennis, with several modifications. Pickleball was invented in the mid-1960s as a children's backyard game.

The balls used in pickleball are unique in that they are constructed of a durable polymer material, and include 26-40 round holes. Balls must be between 73 and 75.5 mm in diameter, and have a maximum out of round diameter of 0.5 mm. Balls must weigh between 22 and 26.5 grams and must also bounce between 30 and 34 inches when dropped from a height of 78 inches onto a granite plate. Ball hardness must conform to between 40 and 50 hardness on the Durometer D scale and must also exhibit straight flight characteristics.

During the course of play or practice, many balls may be used, and some balls inevitably escape onto the court. The balls must be retrieved and stored so that loose balls do not interfere with play and do not cause injury to people who may inadvertently step on a loose ball.

Since pickleball is frequently played in an area where more than one game is played simultaneously, for example four pickleball courts in an enclosed area are common, it is critical that loose balls are retrieved to avoid interference with other games and to provide a safe environment for players. Thus, there is a need for devices used to collect and store pickleballs or other balls such as tennis balls or paddleballs, and the like.

U.S. Pat. No. 2,203,170 (“McDonald”) discloses a ball retriever which includes an upstanding ball receiving tube having a ball receiving and checking assembly at the lower end of the tube. A sack surrounds the tube adjacent its upper end and some distance below the end. The sack is closed at its lower end about the tube and is provided with a normally closed discharge opening for balls.

U.S. Pat. No. 3,117,814 (“Web”) is directed to a golf ball retriever comprising an elongated tube, a handle attached to one end of the tube, means at the other end of the tube for receiving a golf ball therein and prevent exit of the golf ball from the tube. A discharge opening is located at the upper end of the tube, and a bag mounted on the tube in communication with the discharge opening for receiving golf balls from the tube. The means permitting entry of golf balls and preventing exit include a pliable ring having a plurality of inwardly extending deflectable tongues deflectable upwardly during passage of the golf ball through the opening defined by the inner ends of the tongues. Rigid support means are connected to the other end of the tube and extending under the radially outer portions of the tongues so as to permit the tongues to flex into said tube while preventing the tongues from flexing outwardly of the tube.

U.S. Pat. No. 4,063,769 (“Zimmer”) discloses an upstanding tubular member. The lower end of the tubular member is open and defines a downwardly opening mouth of generally circular cross section. An elongated coil spring is supported from the lower end of the tubular member in position extending across the mouth from one side thereof to the other with the spring spaced to one side of the diameter of the mouth paralleling the spring. The mouth, other than the spring, is at least substantially free of obstructions to the passage of a ball upwardly therethrough of a diameter at least slightly greater than the distance between the spring and the side of the mouth on the other side of the diameter. The upper end portion of the tubular member is secured upwardly through the central portion of the bottom of an upwardly opening receptacle and the upper side walls of the receptacle are braced relative to the upper end of the tube and the upper end of the receptacle includes a bail-type handle.

U.S. Pat. No. 5,639,133 (“Mote”) discloses a ball container and dispenser elevated in a standing position by a downwardly extending ball pickup tube and pivotable stand. The tube angles away from the container and dispenser so that the bottom of the tube is forward of the container and dispenser to pick up balls in front of the user. A hinged lid removably covers a top ball dispensing opening in the container and dispenser. The stand pivots to serve as a combination stand in the down position and lid locker in the up position. The rigid element snap fits into paired ridges protruding from the container and dispenser. A handle integral with the lid is shaped like a sports equipment handle and slopes toward the rear. The bottom of the tube is parallel to the ground and has a circular opening smaller than the ball. For hard balls, the opening has radial slots around the perimeter creating resilient tabs.

United States Pub. No. 2011/0269564 (“Mitchell”) discloses a multifunctional sporting apparatus designed for golf practice. A chamber is capable of internally accepting, storing, and releasing a plurality of golf balls configured with a means of detachably securing a plurality of golf clubs and accoutrements. The apparatus includes a stand.

None of these known devices alone or in combination includes all the elements and features of the present invention, thus there is a need for novel devices that can be used to efficiently collect and store pickleballs before, during, or after play of the game.

### SUMMARY

In one aspect of the instant invention, a ball retrieving device includes a storage receptacle. The storage receptacle includes a first flanged portion and a circular collection aperture. A collector tube is attached to the circular collection aperture and may protrude therethrough. The collector tube includes a circumferential groove for retaining a portion of an elastic band. A cover includes second flanged portion for mating with the first flanged portion of storage receptacle. A flange assembly is centrally mounted to the cover, the flange assembly is connected to a disgorging tube.

The ball retrieving device can be configured in a ball retrieving configuration, a stand configuration, and a storage configuration.

In one embodiment, the storage receptacle includes a handle.

In some embodiments, the collector tube includes a central aperture having a diameter D1. The diameter D1 is greater than the diameter D2 of a pickleball.

In certain embodiments, the storage receptacle is attached to the collector tube with an adapter.

In other embodiments, the flange assembly includes a flat land having a diameter D4 for mating with the collector tube. The flat land allows the device to be set at a convenient height for users to access one or more collected pickleballs residing in the storage receptacle.

In some embodiments, the circumferential groove has a length L1. The length L1 can be between about 10 percent and about 40 percent of the length of the circumference of the collector tube.

In yet other embodiments, a central aperture has a length L2. The length L2 is less than a diameter D2 of a pickleball.

In some embodiments, the collector tube has a diameter D1 and the disgorging tube has a diameter D3. The ratio of the diameter D1 to the diameter D3 is greater than 1.

In certain embodiments, the collector tube has a diameter D1, a ball has a diameter D2, and the disgorging tube has a diameter D3. The ratio of the diameter D1 to the diameter D2 is greater than 1. The ratio of the diameter D3 to the diameter D2 is less than 1.

In another aspect of the instant invention, a ball retrieving device includes a storage receptacle. The storage receptacle has a first flanged portion. A collector tube is attached to a circular collection aperture and may protrude therethrough. The collector tube includes a circumferential groove for retaining a portion of an elastic band. The elastic band is mounted through one or more conical retainers. A cover has a second flanged portion for mating with the first flanged portion of storage receptacle. A flange assembly is centrally mounted to the cover and connected to a disgorging tube. The ball retrieving device can be configured in a ball retrieving configuration, a stand configuration, and a storage configuration.

In some embodiments, the storage receptacle includes a handle.

In other embodiments, the collector tube includes a central aperture having a diameter D1. The diameter D1 is greater than a diameter D2 of a pickleball.

In certain embodiments, the storage receptacle is attached to the collector tube with an adapter.

In some embodiments, the flange assembly includes a flat land having a diameter D4 for mating with the collector tube thereby setting the device at a convenient height for users to access one or more collected pickleballs in the storage receptacle.

In certain other embodiments, the circumferential groove has a length L1. The length L1 being between about 10 percent and about 40 percent of a circumference of the collector tube.

In another aspect of the present invention, a method of retrieving and collecting balls includes the steps of: positioning a storage receptacle having a collector tube attached thereto over a ball, the collector tube includes a circumferential groove having an elastic member disposed at least partially therein and a diameter D1; depressing the collector tube over the ball thereby temporarily deflecting the elastic member; capturing the ball within the collector tube; positioning the collector tube over a disgorging tube, the disgorging tube having a diameter D3, wherein the diameter D3 is less than the diameter D1; and lowering the collector tube over the disgorging tube thereby urging the ball through the collector into the storage receptacle.

In some embodiments, the circumferential groove has a length L1. The length L1 is between about 10 percent and about 40 percent of a circumference of the collector tube.

In other embodiments, the elastic band includes a length L2. The length L2 is less than a diameter D2 of a pickleball.

In certain embodiments, the collector tube has a diameter D1 and the disgorging tube has a diameter D3. The ratio of the diameter D1 to the diameter D3 is greater than 1.

In yet other embodiments, the collector tube has a diameter D1, a ball has a diameter D2, and the disgorging tube has a diameter D3. The ratio of the diameter D1 to the diameter D2 is greater than 1. The ratio of the diameter D3 to the diameter D2 is less than 1.

### DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is an isometric view of one embodiment on accordance with the present invention depicting the device is an upright stand condition;

FIG. 2 is isometric view of some of the elements of the device of FIG. 1 in accordance with the present invention;

FIG. 3 is another isometric view of some of the elements of the device of FIG. 1 in accordance with the present invention;

FIG. 4 is an isometric (side) view of some of the elements of the device of FIG. 1 in accordance with the present invention;

FIG. 5 is an isometric view some of the elements of the device of FIG. 1 in accordance with the present invention;

FIG. 6 is a partial isometric view of some of the elements of the device of FIG. 1 in accordance with the present invention;

FIG. 7 is an isometric detail view of some of the elements of the device of FIG. 1 in accordance with the present invention;

FIG. 8 is an is another isometric detail view of some of the elements of the device of FIG. 1 in accordance with the present invention; and

FIG. 9 is an isometric detail view of some of the elements of the device of FIG. 1 in accordance with the present invention including a pickleball.

### DETAILED DESCRIPTION

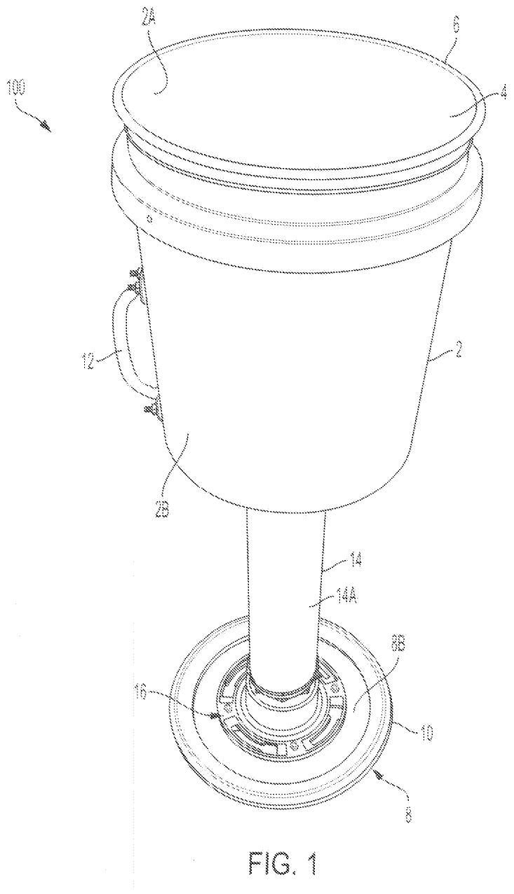

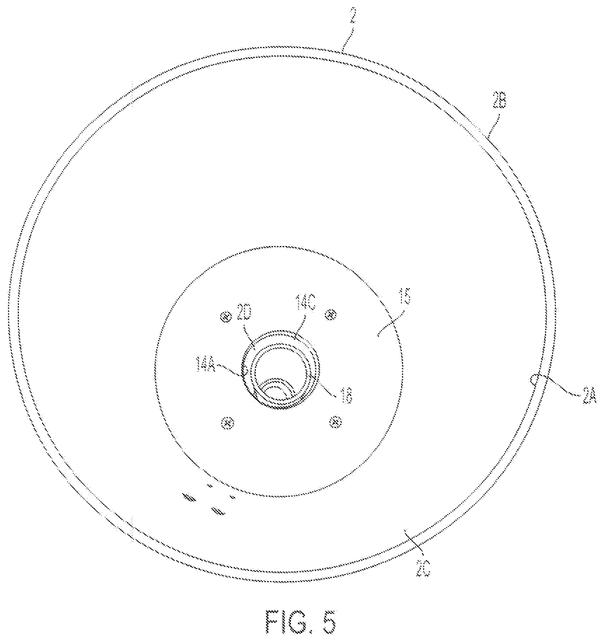

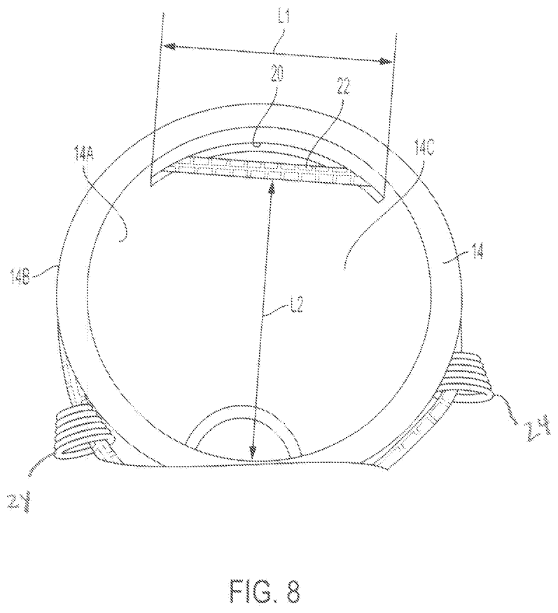

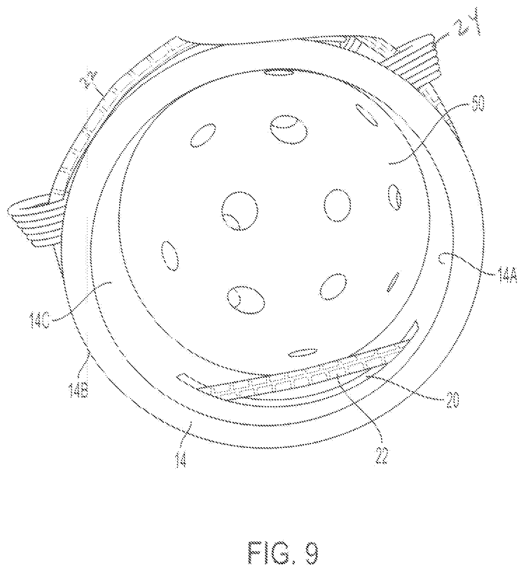

FIGS. 1-9 illustrate one exemplary non-limiting embodiment of a ball retrieving and storage device 100. As depicted in FIGS. 1-9, the ball retrieving and storage device 100 (shown in an upright stand configuration) includes a storage receptacle 2, which can be cylindrical in shape or can be any convenient shape sized to fit a plurality of balls. The storage receptacle 2 includes top aperture 4 having a first flanged portion 6. The first flanged portion 6 can be used to mate with a cover 8 having a corresponding second flanged portion 10. The first and second flanged portions 6, 10 can be used to mate the cover 8 with the top aperture 4 of the storage receptacle 2 to create a removeable snap fit to cover and uncover the top aperture as desired. The storage receptacle can be sized to store about 50 pickleballs. The height of the device and storage capacity can be adjusted, in one embodiment the height can be about 3 feet and the receptacle can be sized to store about 50 pickleballs.

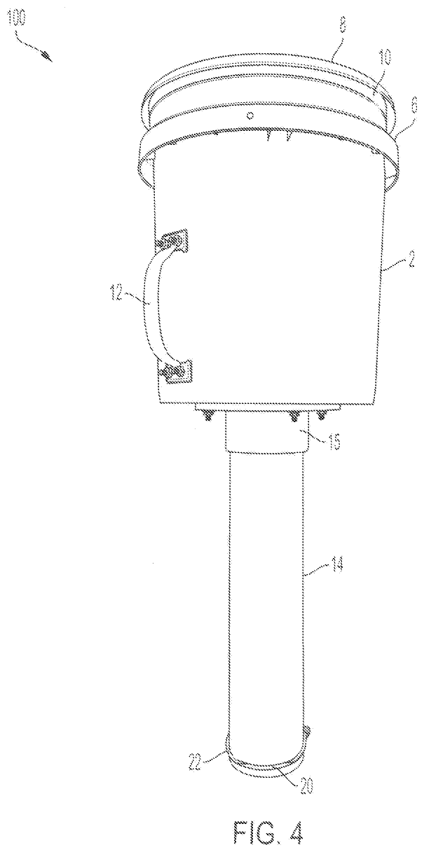

In this embodiment, as detailed for example in FIGS. 4-6, the storage receptacle 2 includes an inner wall 2A, an outer wall 2B, a bottom wall 2C and a circular or cylindrical collection aperture 2D centered in the bottom wall 2C. Collection aperture 2D can be sized to allow a pickleball 50 to pass through it. The storage receptacle 2 can include a handle 12 attached to the outer wall 2B of the storage receptacle 2.

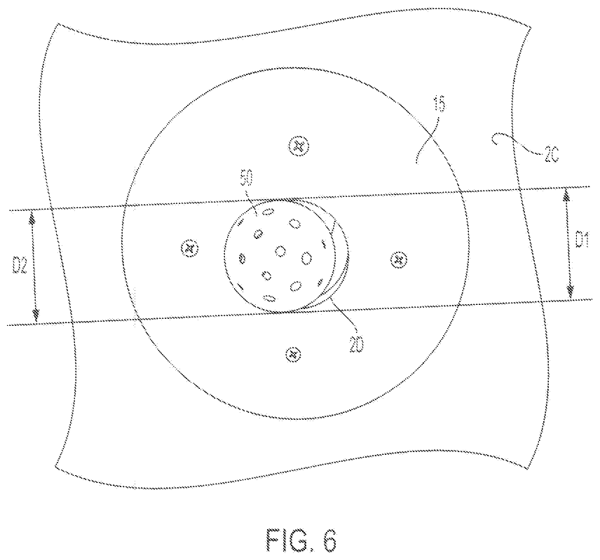

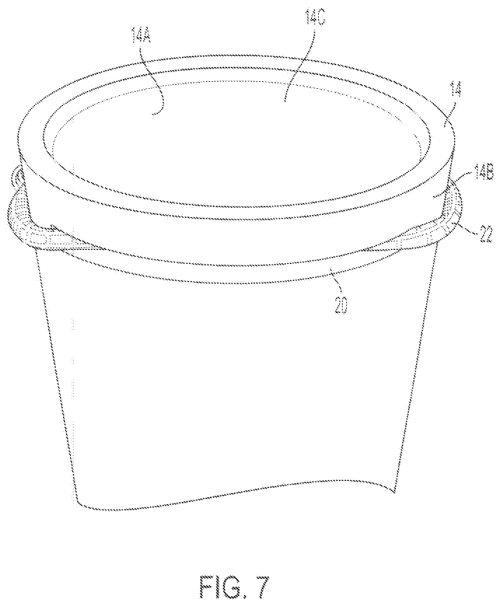

The storage receptacle 2 includes a collector tube 14. Collector tube 14 includes inner wall 14A, outer wall 14B which surround a central aperture 14C (as depicted in FIGS. 7-9). Collector tube 14 is sized so that central aperture 14C has a diameter D1 and pickleball 50 has a diameter D2. The ratio of diameter D1 to diameter D2 is greater than 1.0 as shown in FIG. 6. The collection aperture 2D is extends centrally through adapter 15 which is used to attach collector tube 14 to storage receptacle 2.

Referring now to FIGS. 1-3, the cover 8 includes an outer surface 8A, and an inner surface 8B. A flange assembly 16 is mounted centrally to the inner surface 8B of the cover 8. The flange assembly 16 includes a first portion 16A that can be mounted to the cover 8 and is substantially parallel to the inner surface 8B of the cover and includes a plurality of apertures (not shown) for mounting fasteners 16B therethrough. The flange assembly 16 can be attached to the cover 8 by any known means such as fastener, or adhesive bonding or can be integrally molded for example, in one piece.

Flange assembly 16 includes a second portion 16C. The second portion 16C is substantially perpendicular to the first portion 16A. The second portion 16C of flange assembly 16 include a flat land 16D, having a diameter D4, being connected centrally to ball disgorging tube 18. Disgorging tube 18 has an outer wall 18A and inner wall 18B, a central aperture 18C and a diameter D3.

As shown in FIGS. 7-9, collector tube 14 includes circumferential groove 20 having a length L1. Elastic band 22 is sized to fit within the groove 20 such that a portion having a length L2 of the central aperture 14C is not obstructed by a portion of the elastic band 22. The length L2 can be adjusted by increasing or decreasing the length L1 of circumferential groove 20. The length L2 is less than the diameter D2 of a pickleball 50 thereby allowing the collector tube 14 to be placed over a pickleball 50 and lowered thereby urging the elastic band 22 to temporarily deflect in the region of L1 thus allowing a pickleball 50 to enter the collector tube 14. When the pickleball 50 has entered the collector tube 14, the elastic band 22 returns to its resting position thus capturing the pickleball 50 within the tube 14. Additional pickleballs 50 may be captured using the same process thus forcing each pickleball 50 captured along the collector tube 14 and eventually into the storage receptacle 2.

The device 100 can include one or more conical retainers 24 having an aperture therethrough. The elastic band 22 and be adjusted or circularized to maintain the proper tension, and friction on the elastic band 22 and to maintain the proper functional position of the elastic band 22 on the collector tube 14.

In one particular embodiment, the elastic band 22 is a 3/16″ diameter elastic band whose ends overlap and may be secured by one or more hog rings to produce a circular band about 3¼″ in diameter. The collector tube 14 can include a ¼″ wide groove 20 located about 1 1/16″ from the distal (collecting) end and being about ½″ deep. The interior edge of the distal end of the collector tube 14 can be modified to include a chamfer, for example a 22.5-degree×½″ chamfer. The union of the elastic band 22 and collector tube 14 produces an internal flexible barrier about 2″ in length (L1) and can requires about 1.6 lbs. force to temporarily deflect the elastic band 22 and to allow for rebound as a pickleball 50 passes into the collector tube 14. A backside radial relief about ⅛″ deep can be employed to assist in securing the elastic band 22 on the collector tube 14. The diameter of the storage receptacle can be about 12″ and the device height can be about 3 feet in the stand position.

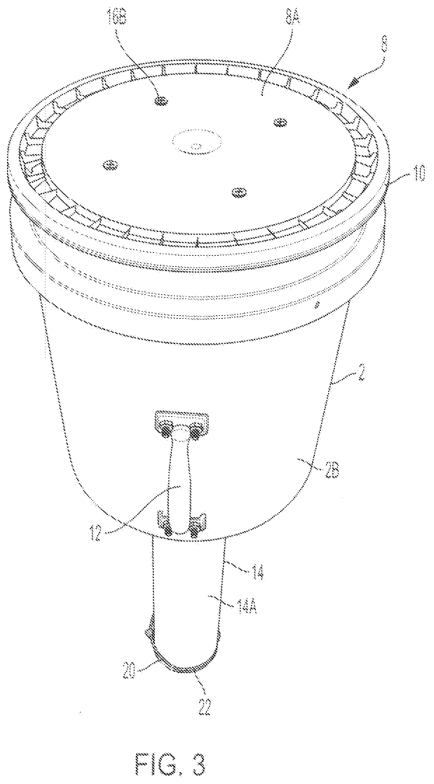

In operation, the device 100 can be used in several configurations. In a storage configuration (FIG. 3), the cover 8 is attached to the storage receptacle 2 thereby nesting the disgorging tube 18 within the storage receptacle 2. Pickleballs 50 may be stored within the storage receptacle 2 in this configuration without falling out and the device 100 may be conveniently carried using the handle 12.

In a stand configuration (FIG. 1), the cover 8 is removed from the storage receptacle 2 and is placed on a hard surface, such as the ground with the outer surface 8A facing the ground. This configuration allows the device 100 to be used as a stand for collected pickleballs 50. By placing the inner wall 14A of the collector tube 14 over outer wall 18A of the disgorging tube 18 the device 100 becomes a self-supporting stand for the storage receptacle 2. In this configuration, when the user places the collector tube 14 over the disgorging tube 18, any pickleballs 50 that have been retained in the collector tube are forced up the collector tube 14 into the storage receptacle for immediate use or storage. The collector tube 14 can mate with the flat land 16D of flange assembly 16 thereby maintaining the device 100 at a convenient height for users to access collected pickleballs 50.

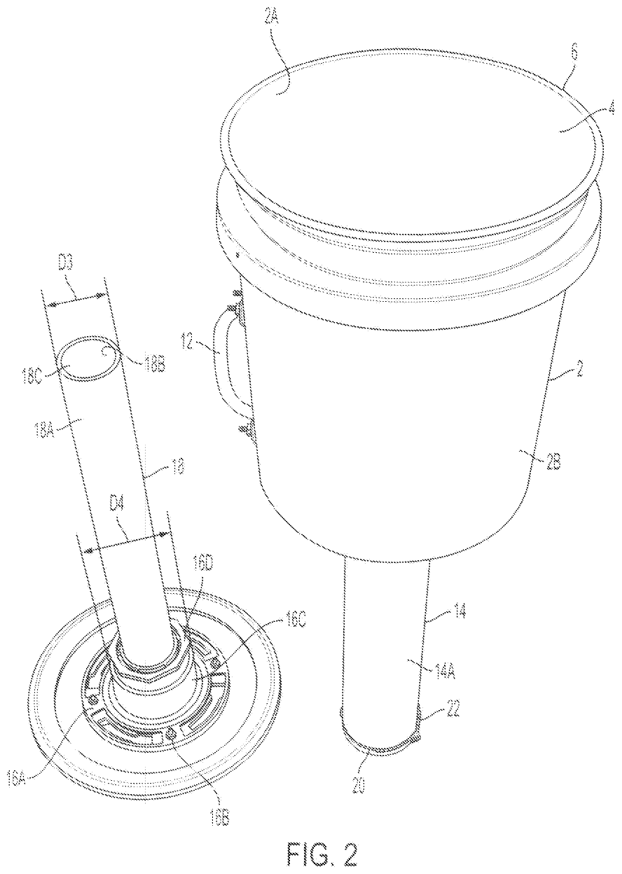

In a collecting configuration (FIG. 2), a user may collect balls using the storage receptacle 2 and collector tube (with or without the cover 8 attached). As discussed above, the user moves the collector tube 14 over each pickleball 50 to be collected and depresses the collector tube 14 so the elastic band 22 deflects and returns to its resting state once the ball 50 passes into the collector tube 14. A plurality of balls 50 can be collected in this manner. When the user is finished collecting balls 50, the user can position the collector tube 14 over the disgorging tube 18 and allow the device 100 to return (by gravity) to the stand configuration. Because the diameter D3 of the central aperture 18C of the disgorging tube 18 is smaller than the diameter D1 of the central aperture 14C of the collector tube, which is larger than D2, the diameter of a pickleball 50, the balls 50 are forced by the disgorging tube 18 along the collector tube 14 and into the storage receptacle 2.

In another embodiment, a second groove and a second elastic band can be added to the collector tube 14 proximate to the storage receptacle 2, so that when balls 50 pass the second elastic band they cannot exit the storage receptacle 2 and enter the collector tube 14.

The ball retrieving and storage device 100 can be made from known materials such as light weight metals or polymers, such as ABS or HDPE. The components can be integrally molded, for example, by using injection molding, compression molding, extrusion, blow molding, or the like, or can be made from separate components for example, by machining, and can be assembled by for example, bonding or fasteners.

In some embodiments, one or more of the collector tube 14 or the disgorging tube 18 can be made from multiple telescoping tube segments so that one or both of the tubes can be collapsed e.g. to fit within the storage receptacle 2. The tubes 14, 18 can also be attached to the storage receptacle and cover, respectively, with any known quick release components so that they may be easily assembled or disassembled.

### COMPONENT LIST

2 storage receptacle.
4 top aperture.
6 first flanged portion.
8 cover.
8A outer surface.
8B inner surface.
10 second flanged portion.
2A inner wall.
2B outer wall.
2C bottom wall.
2D collection aperture.
50 pickleball.
12 handle.
14 collector tube.
14A inner wall.
14B outer wall
14C central aperture.
D1 diameter of central aperture 14C.
D2 diameter of pickleball.
15 adapter.
16 flange assembly.
16A first portion.
16B fasteners.
16C second portion.
16D land.
D4 diameter of land.
18 disgorging tube.
18A outer wall.
18B inner wall.
18C central aperture.
D3 diameter of central aperture 18C.
L1 length of elastic band in retaining region.
Groove 20.
Elastic band 22.
L2 unobstructed length of aperture 14C.
24 conical retainer.

It should be appreciated that the devices disclosed herein although designed for pickleballs, can easily be modified to function for use in collecting or storing other balls such as for example, balls used in tennis, golf, racquetball, paddleball, etc.

Although the present invention has been disclosed and described with reference to certain embodiments thereof, it should be noted that other variations and modifications may be made, and it is intended that the following claims cover the variations and modifications within the true scope of the invention.

What is claimed is:

1. A ball retrieving device comprising:
a storage receptacle, the storage receptacle including a first flanged portion and circular collection aperture;
a collector tube, the collector tube being attached to the circular collection aperture, the collector tube including a circumferential groove for retaining a portion of an elastic band;
a cover, the cover including second flanged portion for mating with the first flanged portion of storage receptacle, and a flange assembly centrally mounted to the cover, the flange assembly being connected to a disgorging tube; and
wherein the ball retrieving device can be configured in a ball retrieving configuration, a stand configuration, and a storage configuration.

2. The ball retrieving device of claim 1, wherein the storage receptacle includes a handle.

3. The ball retrieving device of claim 1, wherein the collector tube includes a central aperture having a diameter D1, the diameter D1 being greater than a diameter D2 of a pickleball.

4. The ball retrieving device of claim 1, wherein the storage receptacle is attached to the collector tube with an adapter.

5. The ball retrieving device of claim 1, wherein the flange assembly includes a flat land having a diameter D4 for mating with the collector tube thereby allowing a user to maintain the device at a convenient height to access one or more collected pickleballs contained in the storage receptacle.

6. The ball retrieving device of claim 1, wherein the circumferential groove has a length L1, the length L1 being between about 10 percent and about 40 percent of a circumference of the collector tube.

7. The ball retrieving device of claim 1, wherein the collector tube includes a length L2, the length L2 being less than a diameter D2 of a pickleball.

8. The ball retrieving device of claim 1, wherein the collector tube has a diameter D1 and the disgorging tube has a diameter D3, the ratio of the diameter D1 to the diameter D3 being greater than 1.

9. The ball retrieving device of claim 1, wherein the collector tube has a diameter D1, a ball has a diameter D2, and the disgorging tube has a diameter D3, the ratio of the diameter D1 to the diameter D2 being greater than 1 and the ratio of the diameter D3 to the diameter D2 being less than 1.

10. A ball retrieving device comprising:
a storage receptacle, the storage receptacle including a first flanged portion;
a collector tube being attached to a circular collection aperture and protruding therethrough, the collector tube including a circumferential groove for retaining a portion of an elastic band, the elastic band being mounted through one or more conical retainers;
a cover including a second flanged portion for mating with the first flanged portion of storage receptacle;
a flange assembly being centrally mounted to the cover and connected to a disgorging tube; and
wherein ball retrieving device can be configured in a ball retrieving configuration, a stand configuration, and a storage configuration.

11. The ball retrieving device of claim 10, wherein the storage receptacle includes a handle.

12. The ball retrieving device of claim 10, wherein the collector tube includes a central aperture having a diameter D1, the diameter D1 being greater than a diameter D2 of a pickleball.

13. The ball retrieving device of claim 10, wherein the storage receptacle is attached to the collector tube with an adapter.

14. The ball retrieving device of claim 10, wherein the flange assembly includes a flat land having a diameter D4 for mating with the collector tube thereby maintaining the device at a convenient height for users to access one or more balls residing in the storage receptacle.

15. The ball retrieving device of claim 10, wherein circumferential groove has a length L1, the length L1 being between about 10 percent and about 40 percent of a circumference of the collector tube.

16. A method of retrieving and collecting balls comprising:
positioning a storage receptacle having a collector tube attached thereto over a ball, the collector tube including a circumferential groove having an elastic band disposed at least partially therein, and a diameter D1;
depressing the tube over the ball thereby temporarily deflecting the elastic band;
capturing the ball within the collector tube;
positioning the collector tube over a disgorging tube, the disgorging tube being mounted to a cover and having a diameter D3, wherein the diameter D3 is less than the diameter D1; and
lowering the storage receptacle and the collector tube over the disgorging tube thereby urging the ball through the collector into the storage receptacle.

17. The method of claim 16, wherein the circumferential groove has a length L1, the length L1 being between about 10 percent and about 40 percent of a circumference of the collector tube.

18. The method of claim 16, wherein the collector tube includes a length L2, the length L2 being less than a diameter D2 of a pickleball.

19. The method of claim 16, wherein the collector tube has a diameter D1 and the disgorging tube has a diameter D3, the ratio of the diameter D1 to the diameter D3 being greater than 1.

20. The method of claim 16, wherein the collector tube has a diameter D1, a ball has a diameter D2, and the disgorging tube has a diameter D3, the ratio of the diameter D1 to the diameter D2 being greater than 1 and the ratio of the diameter D3 to the diameter D2 being less than 1.
